(19) United States
(12) Patent Application Publication
(10) Pub. No.: US 2008/0057359 A1
(43) Pub. Date: Mar. 6, 2008

(54) Flexible fuel cell system configuration to handle multiple fuels

(75) Inventors: Swaminathan Venkataraman, Cupertino, CA (US); Arne Watson Ballantine, Menlo Park, CA (US)

Correspondence Address: FOLEY AND LARDNER LLP;SUITE 500, 3000 K STREET NW, WASHINGTON, DC, 20007, US

(73) Assignee: Bloom Energy Corporation

(21) Appl. No.: 11/896,487

(22) Filed: Aug. 31, 2007

Related U.S. Application Data
(60) Provisional application No. 60/842,361, filed on Sep. 6, 2006.

(51) Int. Cl. H01M 8/00; H01M 8/04; H01M 8/06

(52) U.S. Cl. 429/13; 429/12; 429/19; 429/22; 429/26

(57) ABSTRACT

A fuel cell system comprises a fuel cell system and a fuel source that supplies a plurality of fuels, wherein the fuel cell system is configured to use the plurality of fuels and is configured to switch from one fuel to another. The fuel cell system can execute a seamless transition from one fuel to the other and provides continuous power generation even when an interruption in fuel infrastructure occur.

### CROSS-REFERENCE TO RELATED PATENT APPLICATIONS

This application claims benefit of priority of U.S. provisional application 60/842,361 filed on Sep. 9, 2006, which is incorporated by reference in its entirety.

### FIELD OF THE INVENTION

The present invention relates to a flexible fuel cell system that is configured to handle multiple fuels.

### BACKGROUND

Conventional fuel cells are typically installed and operated on a single, dedicated fuel with the most convenient or available fuel being used. For example, natural gas is a very convenient fuel in most urban settings due to existing natural gas pipeline infrastructure. However, failure in the natural gas pipeline infrastructure can cause an interruption in the supply of natural gas and power generation. For example, such interruptions may occur in areas where earthquakes occur frequently.

### SUMMARY OF THE INVENTION

According to an embodiment, a fuel cell system is configured to use multiple fuels. Such a fuel cell system can be used, for example, to avoid interruptions of fuel and power generation. Different fuels can be used at different periods of fuel cell use. For example, it can be advantageous to use a first fuel during a startup period of fuel cell use and a second fuel during standard operation of a fuel cell.

### BRIEF DESCRIPTION OF THE DRAWINGS

FIG. 1 illustrates a fractionation system for a fuel cell system, according to an embodiment.

FIGS. 2-4 illustrate alternative arrangements of components of a fuel cell system, according to embodiments of the invention.

### DETAILED DESCRIPTION

Embodiments will be described below with reference to the drawings. Embodiments described herein relate to a fuel cell system that can operate with multiple fuels. This fuel cell system can execute a seamless transition from one fuel to the other and advantageously provides continuous power generation, even when interruptions in fuel infrastructure occur. The fuel cell system advantageously allows use of different fuels during different periods of fuel cell use and allows the use of different fuels, including fuels in different states of matter, such as liquid state and gas state fuels.

According to a first embodiment, the fuel cell system can be provided with a first fuel, or main fuel, and a second fuel, or back-up fuel, for system operation. Such an arrangement permits the fuel cell system to continuously operate, even if supply of the first fuel is interrupted, by switching to the second fuel supply.

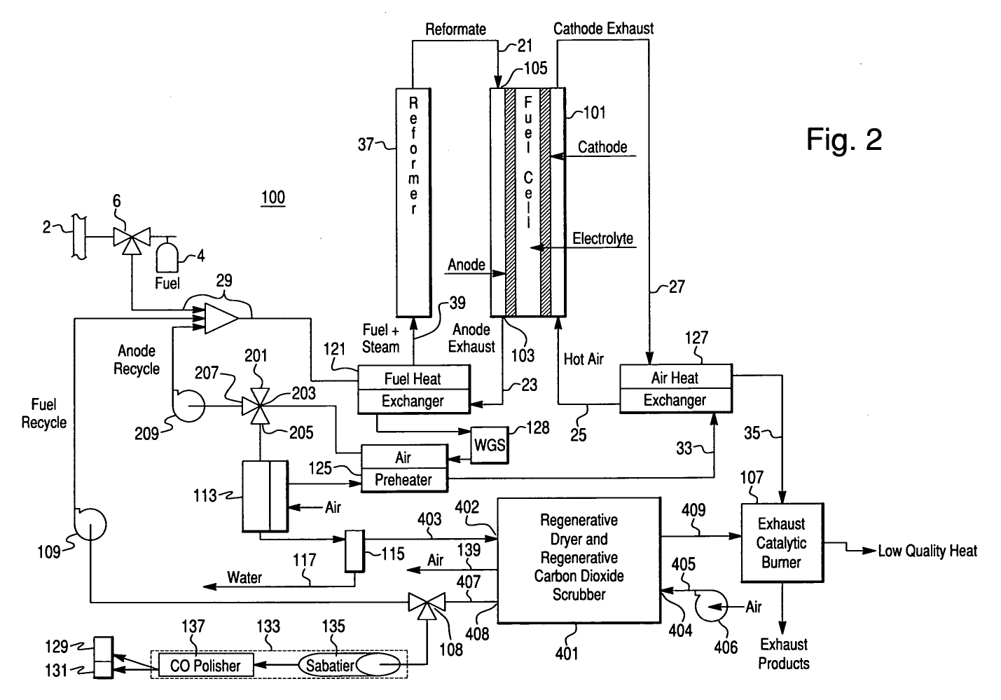

FIGS. 2-4, which are described in more detail below, show arrangements of fuel cell systems in which a plurality of fuel sources is connected to the fuel cell systems. In the examples shown in FIGS. 2-4, a fuel supplied to the fuel cell system can be humidified and sent to the reformer so higher hydrocarbons can be converted before processing in the fuel cell stack.

The fuel cell system can be configured to automatically resume operation with the first fuel when supply of the first fuel are restored. The fuel cell system can also be configured to be manually switched back to the first fuel when supply of the first fuel is restored. For example, natural gas can be provided as a first fuel and ethanol or propane can be provided as a second fuel. If the natural gas infrastructure or supply, such as a natural gas from a pipeline is interrupted due to an earthquake, for example, ethanol or propane stored in a storage vessel, such as a tank, is used as the fuel for the fuel cell system. When the natural gas infrastructure or supply is restored, the fuel cell system can automatically resume operation with natural gas. The system can be configured to be compatible with ethanol by, for example, mixing steam with ethanol and providing a reformer catalyst that is capable of reforming ethanol in addition to the other fuels used by the system. Alternatively, propane can be the first or primary fuel and natural gas or oxidized hydrocarbon fuel can be the second or back up fuel.

A first fuel, or standard fuel, can include, for example: natural gas via pipeline, compressed natural gas, propane, liquid petroleum gas, gasoline, diesel, home heating oil, kerosene, JP-5, JP-8, aviation fuels, hydrogen, ammonia, ethanol, methanol, other oxygenated hydrocarbon fuels, syn-gas (town gas, reformate gas), bio-gas, bio-diesel, or other standard infrastructure fuels.

A second or additional fuel can include, for example, an infrastructure fuel delivered by continuous means, such as a pipeline, generation process, or continuous delivery. In a further example, the second or additional fuel can be a fuel that is stored in a liquid state or a compressed state, such as propane. It should be noted that the first and the second fuels may comprise the same composition but which are provided in different form. For example, the first fuel may comprise natural gas which is continuously provided by a conduit connected to a natural gas pipeline, while the second fuel may comprise natural gas stored in a gas tank as a back-up. If desired, the system can operate on three or more fuels, with a first primary or main fuel and at least two other different backup fuels for extra reliability and/or optimal use of renewable fuels. For example, the fuel cell system can operate on a primary renewable fuel, such as ethanol. The system may have a primary back-up fuel, such as natural gas from a pipeline, which can be readily provided in case the primary renewable fuel becomes unavailable. The system may have at least one secondary back-up fuel, such as fuel oil, stored in a fuel tank. Fuel oil produces more CO₂, but is readily stored and is likely to be available even in an earthquake or other natural disaster, in which natural gas flow from a pipeline is interrupted.

According to a second embodiment, a fuel cell system is provided that can operate with multiple fuels, wherein different fuels can be used during different periods of fuel cell system use. For example, a first fuel can be used during system startup and a second fuel can be used during standard operation of the fuel cell system. This arrangement permits the use of a first fuel that is advantageously suited for use during startup and the use of a second fuel that is advantageously suited for use during standard operation. For example, natural gas can be used as a fuel during system startup, then after the system has been operating for a period of time and waste heat is available for the operation of the pre-reformer components, the system can use bio-diesel as a fuel for standard operation. In this case, the waste heat from the fuel cell stack, such as the fuel and/or air exhaust streams from the stack, can be used to heat the pre-reformer components.

Fuels that can be used for startup can include any fuel that is easily reformed or processed by a solid oxide fuel cell (“SOFC”) system as a fuel. For example, the startup fuel can include natural gas, propane, ethanol, methanol, hydrogen, ammonia, syn-gas, or other such fuels.

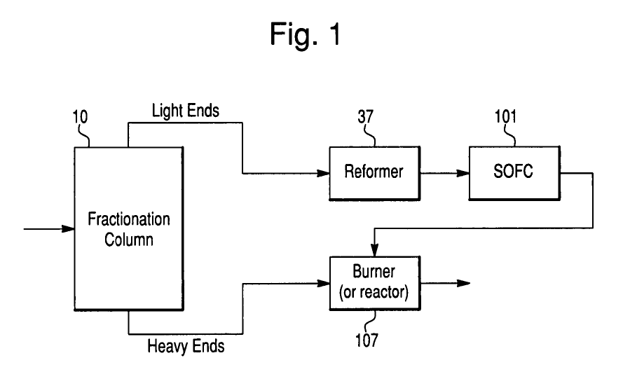

According to a third embodiment, a fuel cell system is provided that can operate with multiple fuels, wherein a liquid fuel is used as one or more fuels. Fuels that can be used in liquid form include, for example, diesel, JP-5, JP-8, gasoline, and other fuels used in liquid form. Such liquid fuels may use reformation processes that make use of fractionation devices to separate heavy fuel portions from light fuel portions. For example, the light portions can be pre-reformed to generate a reformate gas that is processed by the fuel cell system and the heavy portions can be burned to generate heat for the pre-reforming process. FIG. 1 shows an arrangement of a fractionation system for a fuel cell system, according to the third embodiment. As shown in the example of FIG. 1, a fractionation device 10, such as a fractionation column, can be used to separate light portions or ends from heavy portions or ends. The light portions can be pre-reformed in a reformer 37 to generate a reformate gas that is processed by the fuel cell stack 101 and the heavy portions can be burned in a burner 107 to generate heat for the pre-reforming process. The processing of liquid fuels is further discussed in U.S. Provisional Application No. 60/788,044, filed on Apr. 3, 2006, which is hereby incorporated by reference.

An advantage provided by this embodiment is modularity and flexibility in the use of different fuels. For example, a fuel cell system can include a fractionator, a pre-reformer, a reformer, and SOFC cells. When a liquid fuel (such as diesel, JP-5, JP-8, or other liquid or higher hydrocarbon fuel) is used, it is passed through the fractionator, pre-reformer and reformer before it reaches the fuel cells. However, when a gaseous fuel (such as natural gas, propane, vaporized ethanol, or other gaseous or lower hydrocarbon fuel) is used, it can be injected directly into the reformer so that the fractionator and pre-reformer devices are bypassed. According to a further embodiment, when a fuel is injected directly to the reformer, this fuel may be used during the startup period of operation to provide process heat from the fuel cell stack to the fractionator and pre-reformer (such as by providing the hot exhaust streams from the stack to the fractionator and reformer). Once the fractionator and pre-reformer are sufficiently warmed and ready for operation, the fuels can be switched without interruption of system operation.

If desired, the reformer may be omitted if internal reforming type fuel cells are used in the stack which contain a catalyst which can reform the hydrocarbon fuel. Thus, the desulfurized and fractionated higher hydrocarbon fuels, such as JP5, JP8, etc., may be pre-reformed in the pre-reformer. The pre-reformed fuel is then further reformed at the fuel electrodes of the internal reforming type fuel cells. Thus, the reformation of the higher hydrocarbon fuel is complete once the fuel passes through one or more fuel cell stacks.

According to a fourth embodiment, a fuel cell system is provided that can operate with multiple fuels, wherein the fuel cell system makes use of an auto-thermal reformation process. The auto-thermal reformation process can be used to process more complex, high value fuels. This fuel cell system can be used to process fuels such as, for example, diesel, JP-5, JP-8, gasoline, or other complex fuels. In the example of diesel fuel, the fuel can be pre-reformed to produce a mixture of methane, carbon monoxide and hydrogen. The methane is further reformed in the external reformer or at the fuel cell anode electrodes if the fuel cells are of the internal reforming type. The pre-reformation can be controlled so that there is enough slippage of methane to permit cooling for the stacks. In a further example, a combination of fractionation and steam reforming or autothermal reforming can be used for the system.

The reformer catalyst may be optimized to operate on different fuels, such as both liquid and gas fuels and/or both higher and lower hydrocarbon fuels. If an external reformation is used, one reformer with a lower nickel catalyst content may be used to reform the liquid or higher hydrocarbon fuels and a separate reformer with a higher nickel catalyst content may be used to reform the gaseous or lower hydrocarbon fuels.

Alternatively, a single hybrid reformer may be used instead to reform two or more different fuels that are used with the system. Thus, the single reformer allows operation of the system on multiple fuels without requiring separate reformers for different fuels.

A fuel reformer is a device that reforms a hydrocarbon fuel into a fuel stream comprising hydrogen and carbon monoxide. For example, in a steam-methane reformation (SMR) reaction, steam and methane are reformed in a reformer to a stream comprising hydrogen, carbon monoxide and other components. A reformer may comprise a catalyst coated fuel passage, such as a cylinder having the catalyst coated on its interior walls and/or on an insert in the reformer housing. The insert may comprise a catalyst coated tube, foil or wire. Other reformer geometry, such as a rectangular passage or other polygonal passages, may also be used.

The reformer catalyst may comprise a catalyst mixture containing Rhodium and Nickel. Rhodium is used for stability and Nickel is used for reactivity. Noble metals other than Rhodium or in combination with Rhodium may also be used to enhance stability.

The catalyst composition is optimized for handling different fuels. For handling high hydrocarbon fuel, such as diesel and jet fuel (including JP5 and JP8), less Nickel is used to avoid coking. For handling lower hydrocarbon fuels such as natural gas, methane, propane, methanol, ethanol, etc. more Nickel is used. The hybrid reformer contains two segments. The leading segment (i.e., the segment where the fuel enters the reformer) contains less Nickel for reforming high hydrocarbon fuel, such as diesel or jet fuel, and a trailing segment (i.e., the segment where the fuel exits the reformer) contains more Nickel than the leading segment for reforming low hydrocarbon fuel, such as natural gas or methane. The leading segment contains a lower amount and/or concentration of Nickel than the trailing segment. The reformer may comprise a housing and one or more catalyst coated inserts to form the above described low and high Nickel segments. The actual Nickel amount and/or concentration in each segment can be optimized based on the actual fuel that will be used, the system geometry, temperature and other variables.

The reaction kinetics of higher hydrocarbons reforming to methane is faster than the reaction kinetics of methane reforming to produce syngas. Furthermore, the hybrid reformer can also be used together with internal reforming type fuel cells, to allow more methane slippage either by reducing the number of inserts or reducing the coated area of nickel catalyst.

According to a fifth embodiment, a fuel cell system is provided that can operate with multiple fuels, wherein the fuel cell system uses generated hydrogen as one or more of the fuels. For example, the fuel cell system can make use of a hydrocarbon fuel for standard operation. While the hydrocarbon fuel is being used during standard operation, some of the hydrogen or reformate generated during reforming of the hydrocarbon fuel can be stored. For example, an output of a hydrocarbon fuel reformer can be split into two reformate streams. The first stream is provided to the fuel cell stack and the second the hydrogen or reformate stream can be compressed and stored in a storage tank. Alternatively, hydrogen may be separated from the fuel exhaust stream of the fuel cell stack and stored for later use, as described in U.S. application Ser. No. 10/446,704 filed on May 29, 2003, incorporated herein by reference in its entirety. If the supply of hydrocarbon fuel is interrupted, such as due to interruption of the hydrocarbon fuel supply infrastructure (such as a natural gas pipe line supply), then the stored hydrogen or reformate is used by the fuel cell system until the supply of hydrocarbon fuel is restored. An advantage of such an arrangement is that only one infrastructure fuel is required for the fuel cell system. Furthermore, the fuel cell system can place some or all of the cells into electrolysis mode when there is a low demand for electricity generation, especially if the fuel cells comprise reversible fuel cells, such as solid oxide reversible fuel cells, as disclosed in U.S. Pat. No. 7,045,237, incorporated herein by reference in its entirety.

According to a sixth embodiment, a fuel cell system is provided that can operate with multiple fuels, wherein a renewable fuel is used as one of the fuels. Such a system maximizes the use of renewable fuels while optimizing system availability. The fuel cell system can use a liquid renewable fuel, such as, for example, ethanol. A non-renewable fuel, such as, for example, natural gas, can be configured as a second or backup fuel. For example, the fuel cell system can be configured to use the renewable fuel until a first low level signal is triggered, such as when 25% of the renewable fuel is remaining. When this signal is provided, the system switches to the non-renewable fuel supply to maintain a supply of renewable fuel. If the supply of non-renewable fuel is compromised, the system reverts to the renewable supply and consumes the remainder of this supply.

The fuel cell systems of the above embodiments can include control systems to control the steam to carbon ratio. According to an embodiment, the fuel cell system controls can adjust either the water pump flow rate or the anode (i.e., fuel) exhaust stream recycle rate (i.e., the rate or amount of the anode exhaust stream being recycled into the fuel inlet of the stack) as needed to achieve the steam to carbon ratio required for substantially complete reformation of the fuel. For example, during transitions when the fuel cell system is switching from one fuel to another, excess water (i.e., water in an amount greater than that provided during steady-state operation) may be provided to prevent coking of system components. Once steady-state operation is attained on the new fuel that the system has switched to, less water is provided and an optimum water introduction rate is achieved.

For fuel cell systems that use fuels with varying levels of hydrocarbons, such as liquid petroleum gas and other fuels, the fuel cell systems controls can monitor parameters and data to determine a proper steam to carbon ratio. For example, a fuel processing module can be used to monitor parameters, such as, for example, the vapor pressure of the fuel during daytime and nighttime thermal cycles. Using this data, a first level approximation assessment of the steam to carbon ratio can be made for system operation. In another example, other parameters such as, for example, the fraction of heavy portions to light portions of fuels, such as diesel fuel, can be used to make similar assessments.

For fuel cell systems that use fractionation, a control system can perform online analysis of the performance of the system relative to a heat and materials balance to determine a proper steam to carbon ratio. For example, a change in the fuel supplied to the system would be detected based upon analysis of the balance and the ratio of steam to carbon would be adjusted to compensate for the switch in fuel supply.

The fuel cell systems of the above embodiments can implement various devices, processes, and means to trigger a change in fuel supply. For example, a fuel cell system can use a signal to trigger the system change fuel supplies. Such a fuel cell system would use a first fuel supply until the signal triggers a change to a second fuel supply, such as when the first fuel is no longer available.

Various devices can be used to provide signals to trigger a switch in fuel supply. For example, a pressure transducer can be used to detect the availability of a fuel supply in a pipeline, such as a natural gas pipeline, hydrogen pipeline, or other continuous fuel source. When fuel pressure is lost, a signal would indicate that the fuel is unavailable and trigger the system to change fuels. In another example, a level switch or level sensor can be used to detect the availability of liquid fuels, such as, for example, liquid petroleum gas, diesel, ethanol, gasoline, or other liquid fuels in a fuel tank. When the level of fuel is empty or the level of fuel drops below a minimum level, an interrupt signal would trigger a change to another fuel supply. In another example, a communications network can be used to provide a fuel supply interruption signal, such as when a disaster occurs. Such a communications network can include sensors, such as, for example, a seismic sensor to detect the occurrence of earthquakes. Signals produced by such arrangements can be used to indicate interruption or imminent interruption of a fuel supply.

The fuel cell systems of the above described embodiments can be configured to detect the availability of additional or backup fuels. For example, the systems can be configured to switch to the additional or backup fuels in order to verify a supply of these fuels. Such a switch may be triggered manually or automatically by the controls of the fuel cell system. Once supply of the additional or backup fuels is verified, the system reverts to usage of the primary fuel source. Such a configuration can be used when there is a backup power supply available, such as a second fuel cell system or electric grid. This configuration enhances the reliability of system components through their period operation.

The flexible fuel cell systems of the above described embodiments may contain the components described and illustrated below. However, it should be noted that the fuel cell systems may contain different components and configurations than those described and illustrated with respect to the embodiments below. The embodiments below describe and illustrate a schematic of various fuel cell systems, such as a solid oxide fuel cell system, where the fuel exhaust stream is separated into two streams and one of the streams is recycled into the fuel inlet stream. It should be noted that fuel cell systems other than solid oxide fuel cell systems may also be used.

In the system of the seventh embodiment, a portion of the fuel cell stack fuel exhaust stream is directly recycled into the fuel inlet stream. Another portion of the fuel cell stack fuel exhaust stream is provided into a partial pressure adsorption apparatus, and the separated hydrogen is then recycled into the fuel inlet stream and/or is provided to a hydrogen storage vessel or to a hydrogen using device.

FIG. 2 illustrates a fuel cell system 100 of the seventh embodiment. The system 100 contains a fuel cell stack 101, such as a solid oxide fuel cell stack (illustrated schematically to show one solid oxide fuel cell of the stack containing a ceramic electrolyte, such as yttria stabilized zirconia (YSZ) or scandia stabilized zirconia (SSZ), an anode electrode, such as a nickel-YSZ or Ni-SSZ cermet, and a cathode electrode, such as lanthanum strontium manganite (LSM)). The fuel inlet line 29 is connected to a first fuel source 2 which provides the first fuel and to the second fuel source 4 which provides the second fuel different from the first fuel. For example, source 2 may comprise a conduit connected to a natural gas pipeline and source 4 may comprise a fuel storage tank. An operator or computer controlled valve 6 controls which fuel is provided to the fuel cell stack 101.

The system also contains a partial pressure swing adsorption (“PPSA”) unit 401 comprising a plurality of adsorbent beds (not shown for clarity). The PPSA unit 401 acts as a regenerative dryer and carbon dioxide scrubber. The PPSA unit 401 is described in U.S. patent application Ser. Nos. 10/188,118 and 10/188,120, both filed on Jul. 25, 2005 and both incorporated herein by reference in their entirety.

The system 100 also contains the first conduit 403 which operatively connects a fuel exhaust outlet 103 of the fuel cell stack 101 to a first inlet 402 of the partial pressure swing adsorption unit 401. For example, the first inlet 402 may comprise a feed valve and/or an inlet to one of the adsorbent beds. The system 100 also contains the second conduit 405 which operatively connects a purge gas source, such as a dried or atmospheric air source 406 to a second inlet 404 of the partial pressure swing adsorption unit 401. The purge gas source 406 may comprise an air blower or compressor and optionally a plurality of temperature swing cycle adsorption beds.

The system also contains a third conduit 407 which operatively connects an outlet 408 of the partial pressure swing adsorption unit 401 to the hydrogen storage vessel or to the hydrogen using device. If desired, the third conduit 407 also operatively connects an outlet 408 of the partial pressure swing adsorption unit 401 to a fuel inlet 105 of the fuel cell stack 101, as will be described in more detail below. Preferably, the system 100 lacks a compressor which in operation compresses the fuel cell stack fuel exhaust stream to be provided into the partial pressure swing adsorption unit 401.

The system 100 also contains the fourth conduit 409 which removes the exhaust from the unit 401. The conduit 409 may be connected to a catalytic burner 107 or to an atmospheric vent. Optionally, the burner 107 may also be operatively connected to the stack fuel exhaust outlet 103 to provide a portion of the fuel exhaust stream into the burner 107 to sustain the reaction in the burner.

The system 100 also contains an optional selector valve 108, such as a multi-way valve, for example a three-way valve. The selector valve 108 has an inlet operatively connected to an outlet of the partial pressure swing adsorption unit 401, a first outlet operatively connected to the hydrogen storage vessel or to the hydrogen using device, and a second outlet operatively connected to a fuel inlet 105 of the fuel cell stack 101. In operation, the valve 108 divides the hydrogen containing stream provided from the PPSA unit 401 into a first stream, which is provided into the hydrocarbon fuel inlet stream, and a second stream which is provided to the hydrogen storage vessel or to the hydrogen using device. However, the valve 108 may be omitted and the system 100 may be configured to provide the entire hydrogen containing stream into the hydrocarbon fuel inlet stream, or to the hydrogen storage vessel or to the hydrogen using device, if such optional vessel or device are connected to the system 100.

Preferably, the second outlet of the selector valve 108 is operatively connected to the fuel inlet line 29 of the fuel cell stack 101 via a blower or a heat driven compressor 109. The fuel inlet line 29 may be connected to separate fuel sources as described above, such as to a natural gas pipe line and to a fuel storage vessel such as a propane or other hydrocarbon fuel tank. The device 109 has an inlet which is operatively connected to the partial pressure swing adsorption unit 401 (via the selector valve 108) and an outlet which is operatively connected to a fuel inlet 105 of the fuel cell stack 101. For example, conduit 407 connects the blower or compressor 109 to the unit 401 via the selector valve 108. In operation, the blower or compressor 109 controllably provides a desired amount of hydrogen and carbon monoxide separated from a fuel cell stack fuel exhaust stream into the fuel cell stack fuel inlet stream. Preferably, the device 109 provides the hydrogen and carbon monoxide into a fuel inlet line 29 which is operatively connected to the a fuel inlet 105 of the fuel cell stack 101. Alternatively, the device 109 provides the hydrogen and carbon monoxide directly into the fuel inlet 105 of the fuel cell stack 101.

The system 100 also contains a condenser 113 and water separator 115 having an inlet which is operatively connected to a fuel cell stack fuel exhaust 103 and an outlet which is operatively connected to an inlet 402 of the partial pressure swing adsorption unit 401. The condenser 113 and water separator 115 may comprise a single device which condenses and separates water from the fuel exhaust stream or they may comprise separate devices. For example, the condenser 113 may comprise a heat exchanger where the fuel exhaust stream is cooled by a cool counter or co-flow air stream to condense the water. The air stream may comprise the air inlet stream into the fuel cell stack 101 or it may comprise a separate cooling air stream. The separator 115 may comprise a water tank which collects the separated water. It may have a water drain 117 used to remove and/or reuse the collected water.

The system 100 also contains a recuperative heat exchanger 121 which exchanges heat between the stack fuel exhaust stream and the hydrocarbon fuel inlet stream being provided from the inlet line 29. The heat exchanger helps to raise the temperature of the fuel inlet stream and reduces the temperature of the fuel exhaust stream so that it may be further cooled in the condenser and such that it does not damage the humidifier.

If the fuel cells are external fuel reformation type cells, then the system 100 contains a fuel reformer 37. The reformer 37 reforms a hydrocarbon fuel inlet stream into hydrogen and carbon monoxide containing fuel stream which is then provided into the stack 101. The reformer 37 may be heated radiatively, convectively and/or conductively by the heat generated in the fuel cell stack 101 and/or by the heat generated in an optional burner/combustor, as described in U.S. patent application Ser. No. 11/002,681, filed Dec. 2, 2004, incorporated herein by reference in its entirety. Alternatively, the external reformer 37 may be omitted if the stack 101 contains cells of the internal reforming type where reformation occurs primarily within the fuel cells of the stack.

Optionally, the system 100 also contains an air preheater heat exchanger 125. This heat exchanger 125 heats the air inlet stream being provided to the fuel cell stack 101 using the heat of the fuel cell stack fuel exhaust. If desired, this heat exchanger 125 may be omitted.

The system 100 also preferably contains an air heat exchanger 127. This heat exchanger 127 further heats the air inlet stream being provided to the fuel cell stack 101 using the heat of the fuel cell stack air (i.e., oxidizer or cathode) exhaust. If the preheater heat exchanger 125 is omitted, then the air inlet stream is provided directly into the heat exchanger 127 by a blower or other air intake device.

The system may also contain an optional water-gas shift reactor 128. The water-gas shift reactor 128 may be any suitable device which converts at least a portion of the water and carbon monoxide in the fuel exhaust stream into free hydrogen and carbon dioxide. For example, the reactor 128 may comprise a tube or conduit containing a catalyst which converts some or all of the carbon monoxide and water vapor in the fuel exhaust stream into carbon dioxide and hydrogen. Thus, the reactor 128 increases the amount of hydrogen in the fuel exhaust stream. The catalyst may be any suitable catalyst, such as a iron oxide or a chromium promoted iron oxide catalyst. The reactor 128 may be located between the fuel heat exchanger 121 and the air preheater heat exchanger 125.

Optionally, the system 100 is operatively connected to a hydrogen storage vessel 129 or a hydrogen using device 131. However, the vessel 129 or device 131 may be omitted and the system 100 may be used to only produce electricity rather than electricity and hydrogen together. The hydrogen storage vessel may comprise a hydrogen storage tank or a hydrogen dispenser. The vessel may contain a conduit leading to a hydrogen using device which is used in transportation, power generation, cooling, hydrogenation reactions, or semiconductor manufacture. For example, the system 100 may be located in a chemical or a semiconductor plant to provide primary or secondary (i.e., backup) power for the plant as well as hydrogen for use in hydrogenation (i.e., passivation of semiconductor device) or other chemical reactions which require hydrogen that are carried out in the plant.

The hydrogen using device 131 may also comprise another fuel cell system (such as a fuel cell stack), such as low temperature fuel cell system, such as a proton exchange membrane (PEM) fuel cell system, which uses hydrogen as a fuel. Thus, the hydrogen from the system 100 is provided as fuel to one or more additional fuel cells 131. For example, the system 100 may be located in a stationary location, such as a building or an area outside or below a building and is used to provide power to the building. The additional fuel cells 131 may be located in vehicles located in a garage or a parking area adjacent to the stationary location. A vehicle may comprise a car, sport utility vehicle, truck, motorcycle, boat or any other suitable fuel cell powered vehicle. In this case, the hydrocarbon fuel is provided to the system 100 to generate electricity for the building and to generate hydrogen which is provided as fuel to the fuel cell system 131 powered vehicles. The generated hydrogen may be stored temporarily in the hydrogen storage vessel 129 and then provided from the storage vessel to the vehicle fuel cells 131 on demand (analogous to a gas station) or the generated hydrogen may be provided directly from the system 100 to the vehicle fuel cells 131 through a conduit.

The system 100 may contain an optional hydrogen conditioner. The hydrogen conditioner may be any suitable device which can purify, dry, compress (i.e., a compressor), or otherwise change the state point of the hydrogen-rich gas stream provided from the PPSA unit 401. If desired, the hydrogen conditioner may be omitted.

The hydrogen using device 131 may comprise a PEM fuel cell system or another similar device which is generally carbon monoxide intolerant. Thus, carbon monoxide has to be scrubbed (i.e., removed by gas separation and/or chemical reaction) from the hydrogen rich stream being provided from the PPSA unit 401 before the hydrogen rich stream is provided into the PEM fuel cells located in a vehicle or into another CO intolerant device 131.

In this case, the system 100 contains an optional carbon monoxide scrubbing device 133. The device 133 contains an inlet operatively connected to an outlet of the partial pressure swing adsorption unit 401 and an outlet operatively connected to a PEM fuel cell system 131 located in a vehicle. In operation, the carbon monoxide scrubbing device 133 scrubs carbon monoxide being provided with the hydrogen from the partial pressure swing adsorption unit 401 and provides the hydrogen either directly or indirectly to the PEM fuel cell system 131.

The carbon monoxide scrubbing device 133 may comprise any device which removes carbon monoxide from the hydrogen rich stream by adsorption, chemical reaction and/or any other suitable method. The device 133 may comprise a pressure swing adsorption unit and/or a Sabatier reactor. For example, as shown in FIG. 2, the scrubbing device comprises a Sabatier reactor 135 and a carbon monoxide polisher 137. The Sabatier reactor comprises a tube or another container which contains a catalyst, such as a platinum family metal on an alumina support. Preferably, the catalyst comprises ruthenium. A gas mixture consisting primarily of hydrogen and carbon monoxide is introduced into reactor tube from the PPSA system 401 and contacts the catalyst therein. The gas mixture undergoes an immediate exothermic reaction and converts the carbon monoxide and some of the hydrogen to methane and water vapor. Remaining carbon monoxide is then additionally scrubbed from the hydrogen, methane and water vapor gas stream in the polisher 137, which may comprise a silver based adsorption device which adsorbs carbon monoxide. The polisher may comprise plural adsorption beds where one bed adsorbs carbon monoxide while other beds are being regenerated. The outlet stream containing hydrogen, methane and water vapor from the polisher is then provided to the hydrogen storage vessel 129 or the hydrogen using device 131 (the separate purge gas outlet from the polisher 137 is not shown for clarity). The hydrogen may be used as the fuel in the PEM fuel cell system 131, the water vapor may be used to humidify the PEM electrolyte and the methane simply acts as a diluting gas in a PEM system.

Alternatively, the carbon monoxide scrubbing device 133 may comprise a pressure swing adsorption (“PSA”) unit. This unit is similar to the PPSA unit 401, except that a reciprocating compressor is used to pressurize the feed gas into one or more adsorbent beds which contain a material which selectively adsorbs carbon monoxide compared to hydrogen. The pressure swing adsorption unit may operate on a Skarstrom-like PSA cycle. The classic Skarstrom cycle consists of four basic steps: pressurization, feed, blowdown, and purge. For example, the PSA unit may contain two adsorbent beds. When one bed is undergoing pressurization and feed by the compressor, the other column is undergoing blowdown and purge. Three-way valves may be used to direct the feed, purge and product gases between the beds.

Alternatively, the optional device 131 may comprise a carbon monoxide tolerant electrochemical cell, such as a stack of high-temperature, low-hydration ion exchange membrane cells. This type of cell includes a non-fluorinated ion exchange ionomer membrane, such as, for example, a polybenzimidazole (PBI) membrane, located between anode and cathode electrodes. The membrane is doped with an acid, such as sulfuric or phosphoric acid. An example of such cell is disclosed in US published application US 2003/0196893 A1, incorporated herein by reference in its entirety. A stack 131 of these cells may be operated in a fuel cell mode to generate electricity for a vehicle or other uses when hydrogen is provided to the cells of the stack. These cells are carbon monoxide tolerant and operate in a temperature range of above 100 to about 200 degrees Celsius. Thus, the hydrogen containing stream is preferably provided to the stack 131 at a temperature above about 120 degrees Celsius. If a carbon monoxide tolerant device 131 is used, then the carbon monoxide scrubbing device 133 is preferably omitted.

The system 100 also contains a fuel splitter device 201, such as a computer or operator controlled multi-way valve, for example a three-way valve, or another fluid splitting device. The device 201 contains an inlet 203 operatively connected to the fuel cell stack fuel exhaust outlet 103, a first outlet 205 operatively connected to the condenser 113 and water separator 115 and a second outlet 207 operatively connected to the fuel cell stack fuel inlet 105. For example, the second outlet 207 may be operatively connected to the fuel inlet line 29, which is operatively connected to inlet 105. However, the second outlet 207 may provide a portion of the fuel exhaust stream into the fuel inlet stream further downstream.

Preferably, the system 100 contains a second blower or compressor 209 which provides the fuel exhaust stream into the fuel inlet stream. Specifically, the outlet 207 of the valve 201 is operatively connected to an inlet of the blower or compressor 209, while an outlet of the blower or compressor 209 is connected to the hydrocarbon fuel inlet line 29. In operation, the blower or compressor 209 controllably provides a desired amount of the fuel cell stack fuel exhaust stream into the fuel cell stack fuel inlet stream. In one aspect of this embodiment, the device 209 is a low temperature blower which operates at a temperature of 200 degrees Celsius or less. In this case, the heat exchangers 121 and 125 lower the temperature of the fuel exhaust stream to 200 degrees Celsius or less to allow the use of the low temperature blower 209.

The system 100 of the seventh embodiment operates as follows. A fuel inlet stream is provided into the fuel cell stack 101 through fuel inlet line 29. The fuel may comprise any suitable fuel, such as a hydrocarbon fuel, including but not limited to methane, natural gas which contains methane with hydrogen and other gases, propane or other biogas, or a mixture of a carbon fuel, such as carbon monoxide, oxygenated carbon containing gas, such as methanol, or other carbon containing gas with a hydrogen containing gas, such as water vapor, H₂ gas or their mixtures. For example, the mixture may comprise syngas derived from coal or natural gas reformation.

The fuel inlet stream is combined with a portion of the fuel exhaust stream such that hydrogen and humidity (i.e., water vapor) from the fuel exhaust stream is added to the fuel inlet stream. The humidified fuel inlet stream then passes through the fuel heat exchanger 121 where the humidified fuel inlet stream is heated by the fuel cell stack fuel exhaust stream. The heated and humidified fuel inlet stream is then provided into a reformer 37, which is preferably an external reformer. For example, reformer 37 may comprise a reformer described in U.S. patent application Ser. No. 11/002,681, filed on Dec. 2, 2004, incorporated herein by reference in its entirety. The fuel reformer 37 may be any suitable device which is capable of partially or wholly reforming a hydrocarbon fuel to form a carbon containing and free hydrogen containing fuel. For example, the fuel reformer 37 may be any suitable device which can reform a hydrocarbon gas into a gas mixture of free hydrogen and a carbon containing gas. For example, the fuel reformer 37 may comprise a catalyst coated passage where a humidified biogas, such as natural gas, is reformed via a steam-methane reformation reaction to form free hydrogen, carbon monoxide, carbon dioxide, water vapor and optionally a residual amount of unreformed biogas. The free hydrogen and carbon monoxide are then provided into the fuel (i.e., anode) inlet 105 of the fuel cell stack 101. Thus, with respect to the fuel inlet stream, which is located upstream of the reformer 37 which is located upstream of the stack 101.

The air or other oxygen containing gas (i.e., oxidizer) inlet stream is preferably provided into the stack 101 through a heat exchanger 127, where it is heated by the air (i.e., cathode) exhaust stream from the fuel cell stack. If desired, the air inlet stream may also pass through the condenser 113 and/or the air preheat heat exchanger 125 to further increase the temperature of the air before providing the air into the stack 101.

Once the fuel and air are provided into the fuel cell stack 101, the stack 101 is operated to generate electricity and a hydrogen containing fuel exhaust stream. The fuel exhaust stream (i.e., the stack anode exhaust stream) is provided from the stack fuel exhaust outlet 103 into the partial pressure swing adsorption unit 401. At least a portion of hydrogen contained in the fuel exhaust stream is separated in the unit 401 using a partial pressure swing adsorption. The hydrogen separated from the fuel exhaust stream in the unit 401 is then provided into the fuel inlet stream and/or to the hydrogen storage vessel 129 or the hydrogen using device 131.

The fuel exhaust stream is provided into the unit 401 as follows. The fuel exhaust stream may contain hydrogen, water vapor, carbon monoxide, carbon dioxide, some unreacted hydrocarbon gas, such as methane and other reaction by-products and impurities. For example, the fuel exhaust may have a flow rate of between 160 and 225 slpm, such as about 186 to about 196 slpm, and may comprise between about 45 to about 55%, such as about 48-50% hydrogen, about 40 to about 50%, such as about 45-47% carbon dioxide, about 2% to about 4%, such as about 3% water and about 1% to about 2% carbon monoxide.

This exhaust stream is first provided into the heat exchanger 121, where its temperature is lowered, preferably to less than 200 degrees Celsius, while the temperature of the fuel inlet stream is raised. If the air preheater heat exchanger 125 is present, then the fuel exhaust stream is provided through this heat exchanger 125 to further lower its temperature while raising the temperature of the air inlet stream. The temperature may be lowered to 90 to 110 degrees Celsius for example.

The fuel exhaust stream is then separated into at least two streams by the device 201. The first fuel exhaust stream is provided toward device 209 which recycles this first stream into the fuel inlet stream, while the second fuel exhaust stream is directed toward the PPSA unit 401 where at least a portion of hydrogen contained in the second fuel exhaust stream is separated using the partial pressure swing adsorption. At least a portion of the hydrogen separated from the second fuel exhaust stream is then provided to the hydrogen storage vessel 129 or the hydrogen using device 131, and/or a portion of the hydrogen and carbon monoxide separated from the second fuel exhaust stream are provided into the fuel inlet stream in the fuel inlet line 29. For example, between 50 and 70%, such as about 60% of the fuel exhaust stream may be provided to the second blower or compressor 209, while the remainder may be provided toward the PPSA unit 401.

Preferably, the fuel exhaust stream is first provided through the heat exchanger 121, reactor 128 and heat exchanger 125 before being provided into the valve 201. The fuel exhaust stream is cooled to 200 degrees Celsius or less, such as to 90 to 180 degrees, in the heat exchanger 125 prior to being provided into the valve 201 where it is separated into two streams. This allows the use of a low temperature blower 209 to controllably recycle a desired amount of the first fuel exhaust stream into the fuel inlet stream, since such blower may be adapted to move a gas stream which has a temperature of 200 degrees Celsius or less.

The first fuel exhaust stream is provided into the second blower or compressor 209 which recycles this stream into the fuel inlet stream. The device 209 may be computer or operator controlled and may vary the amount of the fuel exhaust stream being provided into the fuel inlet stream depending on any suitable parameters, which include: i) detected or observed conditions of the system 100 (i.e., changes in the system operating conditions requiring a change in the amount of hydrogen or CO in the fuel inlet stream); ii) previous calculations provided into the computer or conditions known to the operator which require a temporal adjustment of the hydrogen or CO in the fuel inlet stream; iii) desired future changes, presently occurring changes or recent past changes in the operating parameters of the stack 101, such as changes in the electricity demand by the users of electricity generated by the stack, changes in price for electricity or hydrocarbon fuel compared to the price of hydrogen, etc., and/or iv) changes in the demand for hydrogen by the hydrogen user, such as the hydrogen using device, changes in price of hydrogen or hydrocarbon fuel compared to the price of electricity.

Furthermore, the second blower or compressor may be operated in tandem with the first blower or compressor 109. Thus, the operator or computer may separately vary the amount of hydrogen being provided into vessel 129 or device 131, the amount of hydrogen and carbon monoxide being provided into the fuel inlet stream by the first blower or compressor 109, and the amount of fuel exhaust stream being provided into the fuel inlet stream by the second blower or compressor 209 based on any suitable criteria, such as the ones described above. Furthermore, the computer or operator may take into account both the amount of hydrogen and carbon monoxide being provided into the fuel inlet stream by the first blower or compressor 109 and the amount of fuel exhaust stream being provided into the fuel inlet stream by the second blower or compressor 209 and optimize the amount of both based on the criteria described above.

The second fuel exhaust stream is provided from the valve 201 into the condenser 113 where it is further cooled to condense additional water vapor from the fuel exhaust stream. The fuel exhaust stream may be cooled in the condenser by the fuel cell stack air inlet stream or by a different air inlet stream or by another cooling fluid stream. The water condensed from the fuel exhaust stream is collected in the liquid state in the water separator 115. Water may be discharged from the separator 115 via conduit 117 and then drained away or reused.

The remaining fuel exhaust stream gas is then provided from the separator 115 as the feed gas inlet stream into inlet 402 of the partial pressure swing adsorption unit 401 via conduit 403. Furthermore, the purge gas inlet stream, such as a dried air stream is provided into the unit 401 from blower or compressor 406 through conduit 405 into inlet 404. If desired, the air stream may be dried using additional adsorbent beds in a temperature swing adsorption cycle before being provided into adsorbent beds of the unit 401. In this case, the heated air used in the temperature swing adsorption cycle to dry the silica gel or alumina in the adsorbent beds may be removed from unit 401 via a vent conduit 139.

Thus, the second fuel exhaust stream comprises hydrogen, carbon monoxide, water vapor, carbon dioxide as well as possible impurities and unreacted hydrocarbon fuel. During the separation step in unit 401, at least a majority of the water vapor and carbon dioxide in the fuel exhaust stream are adsorbed in at least one adsorbent bed while allowing at least a majority of the hydrogen and carbon monoxide in the fuel exhaust stream to be passed through the at least one adsorbent bed. Specifically, unpressurized fuel exhaust stream is provided into the first adsorbent bed to adsorb at least a majority of the water vapor and carbon dioxide remaining in the fuel exhaust stream in the first adsorbent bed until the first adsorbent bed is saturated, while the second adsorbent bed is regenerated by providing air having a relative humidity of 50% or less at about 30 degrees Celsius through the second adsorbent bed to desorb adsorbed carbon dioxide and water vapor. After the first bed is saturated with carbon dioxide, the unpressurized fuel exhaust stream is provided into the second adsorbent bed to adsorb at least a majority of the remaining water vapor and carbon dioxide in the fuel exhaust stream in the second adsorbent bed until the second adsorbent bed is saturated while regenerating the first adsorbent bed by providing air having a relative humidity of 50% or less at about 30 degrees Celsius through the first adsorbent bed to desorb the adsorbed carbon dioxide and water vapor.

The hydrogen and carbon monoxide separated from the fuel exhaust stream (i.e., feed gas outlet stream) are then removed from unit 401 through outlet 408 and conduit 407 and provided into the optional selector valve 108. The valve 108 divides the hydrogen containing stream provided from the PPSA unit 401 into a first stream, which is provided into the hydrocarbon fuel inlet stream in the inlet line 29, and a second stream which is provided to the hydrogen storage vessel 129 or the hydrogen using device 131.

The valve 108 may divide the hydrogen containing stream into contemporaneous first and second streams, such that the first and the second streams are provided from the valve 108 at the same time. The valve 108 may vary the ratio of how much of the hydrogen containing stream provided from the PPSA unit 401 is provided into a first stream and how much of the hydrogen containing stream is provided into the second stream over time. Alternatively, the valve 108 may alternate between providing at least 90-100% of the hydrogen containing stream into the hydrocarbon fuel inlet stream and providing 90 to 100% of the hydrogen containing stream to the hydrogen storage vessel 129, for example. If desired one of the steams may be omitted and the valve 108 may simply constantly direct the hydrogen containing stream into either the vessel 129/device 131 or into the fuel inlet line 29.

The valve 108 may be operated by a computer and/or by an operator to controllably provide a desired amount of hydrogen into the fuel inlet stream and/or to one of the hydrogen storage vessel and the hydrogen using device. The computer or operator may vary this amount based on any suitable parameter. The parameters include: i) detected or observed conditions of the system 100 (i.e., changes in the system operating conditions requiring a change in the amount of hydrogen or CO in the fuel inlet stream); ii) previous calculations provided into the computer or conditions known to the operator which require a temporal adjustment of the hydrogen or CO in the fuel inlet stream; iii) desired future changes, presently occurring changes or recent past changes in the operating parameters of the stack 101, such as changes in the electricity demand by the users of electricity generated by the stack, changes in price for electricity or hydrocarbon fuel compared to the price of hydrogen, etc., and/or iv) changes in the demand for hydrogen by the hydrogen user, such as the hydrogen using device, changes in price of hydrogen or hydrocarbon fuel compared to the price of electricity, etc.

The second hydrogen rich stream may be provided directly to vessel 129 or device 131 or it may first be provided through the carbon monoxide scrubbing device 133 to scrub carbon monoxide from the second stream before providing the stream to a carbon monoxide intolerant device. For example, the second hydrogen stream may be first provided to the hydrogen storage vessel 129 and then provided from the hydrogen storage vessel 129 to the hydrogen using device, such as a PEM fuel cell system 131 in a vehicle, on demand or according to a predefined schedule. Alternatively, the second hydrogen stream may be provided to the hydrogen using device, such as a PEM fuel cell system 131 without first being provided to the hydrogen storage vessel 129.

The first hydrogen rich stream provided from the selector valve is recycled into the fuel inlet stream in the fuel inlet line 29. Preferably, this first hydrogen rich stream containing hydrogen and carbon monoxide is first provided into a blower or compressor 109, which is then used to controllably provide a desired amount of hydrogen and carbon monoxide separated from the fuel exhaust stream into the fuel inlet stream. The blower or compressor 109 may be operated by a computer or by an operator to controllably provide a desired amount of hydrogen and carbon monoxide into the fuel inlet stream, and may vary this amount based on any suitable parameter. The parameters include: i) detected or observed conditions of the system 100 (i.e., changes in the system operating conditions requiring a change in the amount of hydrogen or CO in the fuel inlet stream); ii) previous calculations provided into the computer or conditions known to the operator which require a temporal adjustment of the hydrogen or CO in the fuel inlet stream; and/or iii) desired future changes, presently occurring changes or recent past changes in the operating parameters of the stack 101, such as changes in the electricity demand by the users of electricity generated by the stack, etc. Thus, the blower or compressor may controllably vary the amount of hydrogen and carbon monoxide provided into the fuel inlet stream based on the above described and/or other criteria. Since the hydrogen and carbon monoxide are cooled to 200 degrees Celsius or less, a low temperature blower may be used to controllably provide the hydrogen and carbon monoxide into the line 29. If desired, the selector valve 108 and the blower or compressor 109 may be omitted and the entire hydrogen rich stream may be provided from the PPSA unit 401 to the hydrogen storage vessel 129 or the hydrogen using device 131.

The purge gas outlet stream from the PPSA unit may contain a trace amount of hydrogen and/or hydrocarbon gases trapped in the void volumes of the adsorbent beds. In other words, some trapped hydrogen or hydrocarbon gas may not be removed into conduit 407 by the flush steps. Thus, it is preferred that conduit 409 provide the purge gas outlet stream from PPSA unit 401 to a burner 107. The stack 101 air exhaust stream is also provided through heat exchanger 127 into the burner 107. Any remaining hydrogen or hydrocarbon gas in the purge gas outlet stream is then burned in the burner to avoid polluting the environment. The heat from the burner 107 may be used to heat the reformer 37 or it may be provided to other parts of the system 100 or to a heat consuming devices outside the system 100, such as a building heating system.

Thus, with respect to the fuel exhaust stream, the heat exchanger 121 is located upstream of the heat exchanger 125, which is located upstream of the condenser 113 and water separator 115, which is located upstream of the PPSA unit 401, which is located upstream of blower or compressor 109 which is located upstream of the fuel inlet line 29.

If desired, the system 100 may be used together with a humidifier. Such a system could then be operated in different modes to optimize electricity generation or to optimize hydrogen production for the hydrogen storage vessel 129 or the hydrogen using device 131. The system may be switched between different modes depending on the demand for and/or price of electricity and hydrogen or other factors.

The humidifier may having a first inlet operatively connected to a hydrocarbon fuel source, such as the hydrocarbon fuel inlet line 29, a second inlet operatively connected to the valve 201, a first outlet operatively connected to the fuel cell stack fuel inlet 105, and a second outlet operatively connected to the condenser 113 and water separator 115. In operation, the fuel humidifier humidifies a hydrocarbon fuel inlet stream from line 29 containing the recycled hydrogen and carbon monoxide using water vapor contained in a fuel cell stack fuel exhaust stream. The fuel humidifier may comprise a polymeric membrane humidifier, such as a Nafion® membrane humidifier, an enthalpy wheel or a plurality of water adsorbent beds, as described for example in U.S. Pat. No. 6,106,964 and in U.S. application Ser. No. 10/368,425, both incorporated herein by reference in their entirety. For example, one suitable type of humidifier comprises a water vapor and enthalpy transfer Nafion® based, water permeable membrane available from Perma Pure LLC. The humidifier passively transfers water vapor and enthalpy from the fuel exhaust stream into the fuel inlet stream to provide a 2 to 2.5 steam to carbon ratio in the fuel inlet stream. The fuel inlet stream temperature may be raised to about 80 to about 90 degrees Celsius in the humidifier.

When the system is operated to optimize electricity generation (i.e., to optimize the AC electrical efficiency of the system), the selector valve 108 provides the entire hydrogen rich stream from the PPSA unit 401 back into the fuel inlet conduit. The valve 201 provides a portion of the fuel exhaust stream into the fuel inlet line 29 to humidify the fuel inlet stream. In this case, the valve 201 may route the fuel exhaust stream into the fuel inlet conduit to by-pass the humidifier. The per pass fuel utilization rate is maximized to the highest reasonable operating value, such as about 75% to about 80%, for example, to optimize the electricity production. In this case, no hydrogen is provided to the hydrogen storage vessel 129 or to the hydrogen using device 131.

When the system is operated to optimize hydrogen generation for the hydrogen storage vessel 129 or to the hydrogen using device 131, the selector valve 108 provides the entire hydrogen rich stream from the PPSA unit 401 to the hydrogen storage vessel 129 or to the hydrogen using device 131. No hydrogen rich stream is provided into the fuel inlet conduit. In this case, the valve 201 provides the entire fuel exhaust stream from the stack into the humidifier where the fuel inlet stream is humidified, rather than providing a portion of the fuel exhaust stream into the fuel inlet line 29. The per pass fuel utilization rate is minimized to the lowest reasonable operating value, such as about 55% to about 60%, for example, to optimize the hydrogen production. In this case, a maximum amount of hydrogen is provided to the hydrogen storage vessel 129 or to the hydrogen using device 131. Furthermore, more hydrocarbon fuel may be provided to the fuel cell stack when the system operates to optimize hydrogen production than when the system operates to optimize electrical efficiency. For example, 50-100% more hydrocarbon fuel is provided to the stack 101 when the system is operating to optimize hydrogen production than when the system is operating to optimize electrical efficiency.

The system may also be operated to balance electrical efficiency and hydrogen production. In this case, the selector valve 108 splits the hydrogen rich stream from the PPSA unit 401 between the fuel inlet line 29 and the hydrogen storage vessel 129/hydrogen using device 131. Both steams may be provided at the same time or the valve may alternate between providing the first and the second streams. The amount of hydrogen provided between the two streams can be varied depending on the conditions described above. In this case, the valve 201 may provide the fuel exhaust stream into the fuel inlet stream and/or into the humidifier 119, depending on the desired parameters.

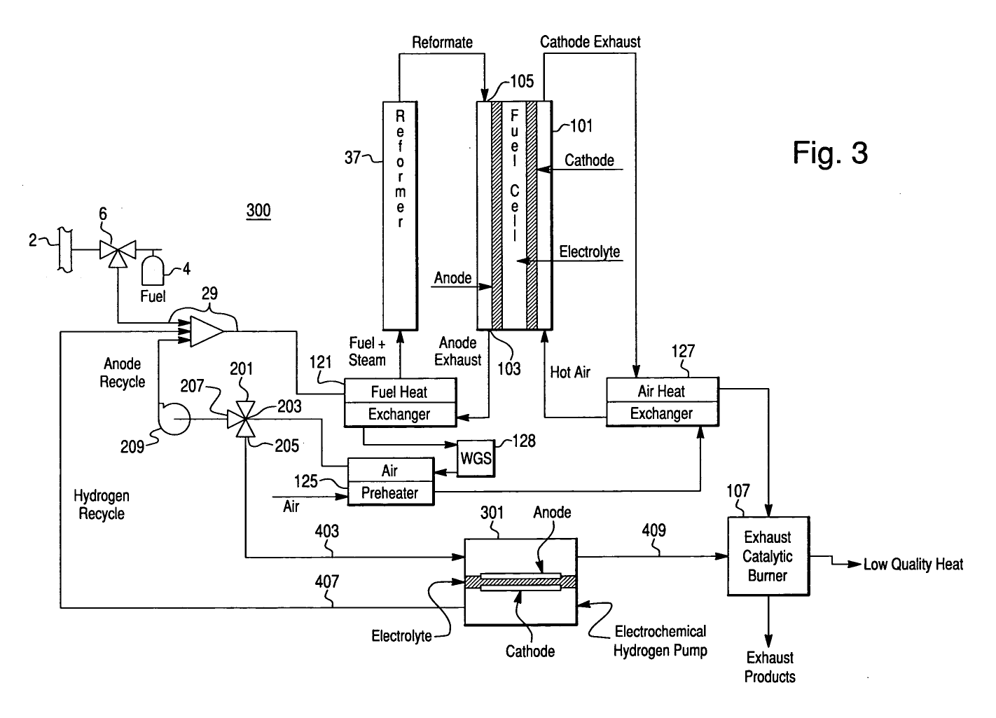

FIG. 3 illustrates a system 300 according to the eighth embodiment of the invention. The system 300 is similar to system 100, except that the PPSA unit 401, the condenser 113 and water separator 115 are replaced with an electrochemical hydrogen pump 301. The pump 301 electrochemically separates hydrogen from the fuel exhaust stream.

The electrochemical pump 301 may comprise any suitable proton exchange membrane device comprising a polymer electrolyte. The hydrogen diffuses through the polymer electrolyte under an application of a potential difference between anode and cathode electrodes located on either side of the electrolyte. Preferably, the electrochemical pump comprises a stack of carbon monoxide tolerant electrochemical cells, such as a stack of high-temperature, low-hydration ion exchange membrane cells. This type of cell includes a non-fluorinated ion exchange ionomer membrane, such as, for example, a polybenzimidazole (PBI) membrane, located between anode and cathode electrodes. The membrane is doped with an acid, such as sulfuric or phosphoric acid. An example of such cell is disclosed in US published application US 2003/0196893 A1, incorporated herein by reference in its entirety. These cells operate in a temperature range of above 100 to about 200 degrees Celsius. Thus, the heat exchangers 121 and 125 preferably keep the fuel exhaust stream at a temperature of about 120 to about 200 degrees Celsius such as about 160 to about 190 degrees Celsius. FIG. 3 does not illustrate for clarity the valve 108 and hydrogen storage vessel 129 or the hydrogen using device 131. However, these devices may be used in the system 300 if desired. Since the pump 301 provides a hydrogen stream that lacks a substantial amount of carbon monoxide, the CO scrubber 135 is not required to be used with the pump 301 and the hydrogen is provided into the fuel inlet stream without the carbon monoxide.

The method of operating the system 300 is similar to the method of operating the system 100, except that the fuel exhaust stream is provided directly from valve 201 into the electrochemical pump 301, which electrochemically separates the hydrogen from the fuel exhaust stream. Furthermore, the blower or compressor 109 may be omitted if the pump 301 is capable of controllably providing a desired amount of hydrogen into the fuel inlet stream. In the method of the eighth embodiment, the effective fuel utilization rate is about 94% and the electrical efficiency is about 58% when the per pass fuel utilization rate is 75%, 60% of the fuel exhaust stream is recycled into the fuel inlet stream by valve 201 and about 85% of the hydrogen is recovered from the remaining fuel exhaust stream by pump 301 and recycled into the fuel inlet stream.

In a ninth embodiment of the invention, a temperature swing adsorption (“TSA”) unit is used to separate hydrogen from the fuel exhaust stream instead of the PPSA unit 401. A TSA unit also does not require the feed gas to be pressurized.

The TSA unit also contains a plurality of adsorbent beds of material which preferentially adsorbs carbon dioxide and water vapor to hydrogen and carbon monoxide. The fuel exhaust stream is provided to at least one first adsorbent bed which is maintained at room temperature or other low temperature to adsorb at large portion of carbon dioxide and water vapor from the fuel exhaust stream. When the first beds is saturated with carbon dioxide and water vapor, the fuel exhaust stream is switched to at least one second adsorbent bed. The first bed is then purged to release the adsorbed carbon dioxide and water vapor by increasing the temperature of the first bed. For example, the first bed may be heated by heat provided by the fuel cell stack, such as by providing the hot stack cathode air exhaust in heat exchange with the first bed. After purging, the first bed is then cooled with ambient air heat exchange. The cycle continues through the multiple beds to provide a constant recovery and circulation of the fuel. This embodiment is also amenable to the sequestration of carbon dioxide.

Rather than providing air in heat exchange with (i.e., adjacent to) the beds, the hot cathode exhaust may be directed through the adsorbent beds directly (with no separate heat exchanger) to discharge the carbon dioxide and water vapor. Then cool ambient air is passed directly through the beds to condition the beds for the next cycle. If desired, a small quantity of nitrogen may be is purged through the beds before and after the bed is reconditioned for additional carbon dioxide and water adsorption. The nitrogen is obtained from a small temperature swing adsorption device using air as the working fluid.

If desired, the TSA effluent, such as the carbon dioxide and water vapor containing effluent, may be discharged to ambient or removed via a vacuum pump after the purge gas is stopped. The vacuum removes more of the residual carbon dioxide and water (a process akin to pressure-swing adsorption, and commonly referred to as vacuum-swing adsorption) which might offer a less expensive and faster means to cool the bed than might be achieved using cool air or heat exchange. The use of the vacuum may also be amenable to the sequestration of carbon dioxide.

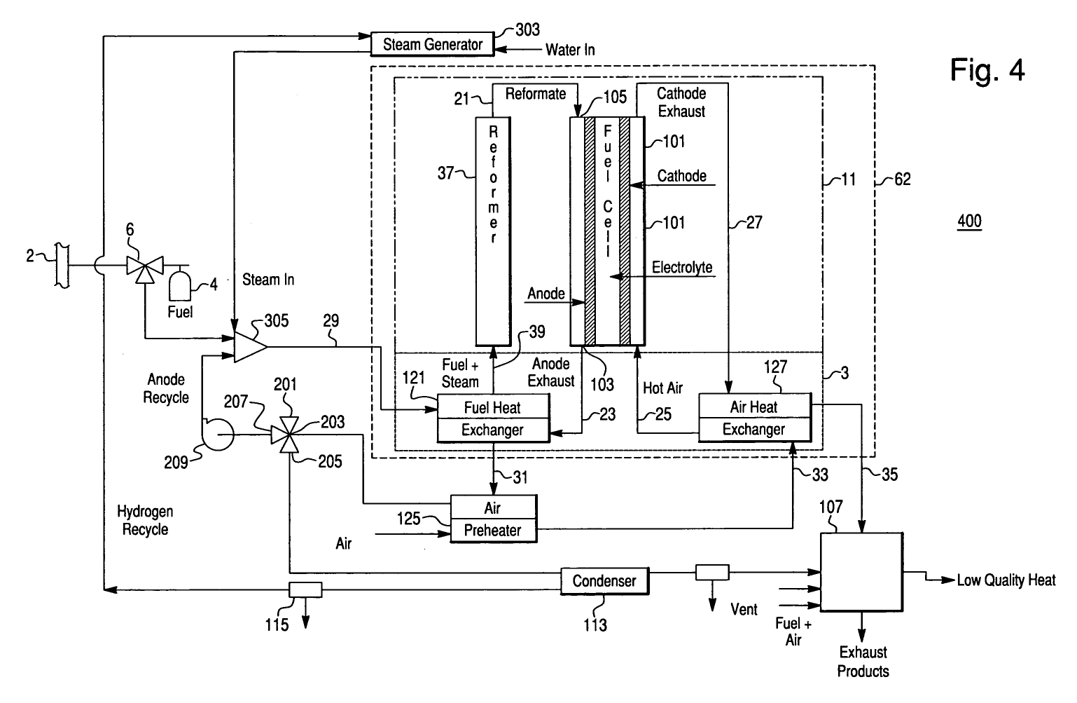

FIG. 4 illustrates a system 400 according to the tenth embodiment of the invention. The system 400 is similar to system 100, except that the PPSA unit 401 and the blower or compressor 109 are omitted.

If desired, a steam generator 303 may also be added to the system 400. The steam generator 303 is provided with water from a water source, such as a water tank and/or from the condenser 113 and water separator 115, and converts the water to steam. The steam is mixed with the inlet fuel stream in a mixer 305. The steam generator may be heated by a separate heater and/or by the hot cathode exhaust stream and/or by the low quality heat generated by the burner 107. Furthermore, the low quality heat generated by the burner 107 may be used to heat the reformer instead of or in addition to heating the steam generator 303. The exhaust products of the burner 107 may be provided into the air inlet stream directed into the fuel cell stack. The steam generator 303 and the air preheater 125 may be located in a separate hot box annex which is placed in contact with the hot box 62. For example, the hot box annex may comprise a separate container located on top of the hot box. It should be noted that the above described features may also be provided into the systems 100 and 300 described above. The hot box contains thermally integrated stack and reformer region 11 and the heat exchanger region 3.

The method of operating the system 400 is similar to the method of operating the system 100, except that the second fuel exhaust stream provided from valve 201 is not subjected to hydrogen separation. Instead, the second fuel exhaust stream provided from the valve 201 is either vented or provided to the burner 207. This system 400 is thus simpler than the systems of the prior embodiments, since it does not include hydrogen separation steps and equipment.

The method of operating the system 400 allows the use of a low temperature blower 209 by cooling the fuel exhaust stream to about 90 to 110 degrees Celsius in heat exchangers 121 and 125. In the method of the tenth embodiment, the electrical efficiency is about 54% when the per pass fuel utilization rate is 75% and 60% of the fuel exhaust stream is recycled into the fuel inlet stream by valve 201. The method of the tenth embodiment is similar to the method of the seventh embodiment up to the point where the fuel exhaust stream is provided into the device 201. As noted above, the fuel splitter device 201 is preferably a computer or operator controlled multi-way valve, such as a three-way valve. The valve 201 separates the fuel exhaust stream into a first separated fuel exhaust stream and a second separated fuel exhaust stream. The first separated fuel exhaust stream is provided into the blower 209 from valve 201 outlet 207. The blower 209 recycles the first separated fuel exhaust stream into the fuel inlet stream at the mixer in the fuel inlet conduit 29. Preferably, as noted above, the blower 209 is a low temperature blower which recycles the first separated fuel exhaust stream having a temperature of 200 C or less into the fuel inlet stream.

In one aspect of the present embodiment, the amount of fuel exhaust provided into the fuel inlet stream is controlled by an operator or automatically by a computer to achieve a steam to carbon ratio of between 2:1 and 2.3:1 in the fuel inlet stream. The first separated fuel exhaust stream contains steam and the fuel inlet stream comprises a hydrocarbon fuel inlet stream, such as a methane or natural gas stream. Thus, the amount of fuel exhaust (and thus the amount of steam) provided into the fuel inlet stream is controlled to achieve a steam to carbon ratio of between 2:1 and 2.3:1, such as a 2.2:1 ratio, in the fuel inlet stream. For methane fuel, each methane molecule provided into the reformer contains one carbon atom. Thus, the H₂O:C molar ratio is based on the ratio of H₂O molecules to methane molecules. However, for other hydrocarbon fuels which contain hydrocarbon molecules with more than one carbon atom per molecule, the ratio of H₂O molecules to such hydrocarbon molecules would be greater than 2.3:1 to maintain the desired steam to carbon ratio. The amount of fuel exhaust being recycled into the fuel inlet stream can be varied continuously or intermittently to continuously maintain the steam to carbon ratio between 2:1 and 2.3:1 in the fuel inlet stream during operation of the fuel cell stack. This steam to carbon ratio is advantageous for optimum steam-methane reformation in the reformer 123.

As used herein, the term “controllably” means that the amount of fuel exhaust provided into a fuel inlet stream is actively controlled as opposed to passively provided into the fuel inlet stream without control. Thus, simply routing a part of the exhaust stream into the fuel inlet stream through a “T”-shaped branched pipe is not controllably providing the exhaust stream into the inlet stream. The amount of fuel exhaust being recycled can be controlled by the operator or by a computer by controlling one or both of the valve 201 and/or the blower 209. For example, the valve 201 may be controlled to vary the ratio of the first separated fuel exhaust stream to the second separated fuel exhaust stream. In other words, if more steam is needed in the fuel inlet stream, then the valve increases the portion of the fuel exhaust stream which is provided into the first separated fuel exhaust stream. If less steam is needed in the fuel inlet stream, then the valve decreases the portion of the fuel exhaust stream which is provided into the first separated fuel exhaust stream. The blower 209 may be controlled by increasing or decreasing the blowing speed or rate to increase or decrease the amount of fuel exhaust being provided by the blower 209 into the fuel inlet stream depending on whether more or less steam is required in the fuel inlet stream.

Preferably, at least one operating parameter of the fuel cell system is detected (i.e., monitored) to determine the amount of fuel exhaust that needs to be recycled into the fuel inlet stream. For example, the temperature of the stack or balance of plant components may be monitored with a temperature sensor, the fuel inlet and exhaust flows may be monitored with a gas flow meter, the amount of power, current or voltage generated by the stack may be monitored by an appropriate electronic detector (i.e., watt meter, volt meter, amp meter, etc.), etc. Based on the detected operating parameter(s), the computer or operator then varies at least one of a ratio of the first separated fuel exhaust stream to the second separated fuel exhaust stream or an amount in the first separated fuel exhaust stream being recycled into the fuel inlet stream by the blower. For example, a computer may be used to automatically control the multi-way valve 201 and/or the blower 209 based on the detected parameters being provided into the computer from one of the system detectors (i.e., sensors). Alternatively, the operator may control the valve 201 and/or blower 209 by using the system control panel based on displayed parameter(s).

The second separated fuel exhaust stream is provided from the output 205 of the valve 201 into the burner 107. The second stream may be provided directly or indirectly from the valve 201 into the burner 107. For example, the output 205 of the valve 201 may be directly connected to the burner 107 by a conduit. If desired, additional air and/or fuel may be provided to the burner 107 from outside the system. Alternatively, in an indirect connection, an optional condenser 113 may be provided between the output 205 of valve 201 and the burner 107. In that case, water is removed from the second separated fuel exhaust stream before the this stream enters the burner 107. The water from the optional condenser may be provided into an optional steam generator which is heated by an exhaust stream of the fuel cell stack, as described in U.S. application Ser. No. 11/124,120 filed on May 9, 2005. The steam generator may be positioned inside the hot box or in contact with a surface of the hot box. The steam generator provides water vapor (steam) into the fuel inlet stream. A single mixer may be used to mix the fuel inlet stream, the first separated fuel exhaust stream and the steam from the steam generator. The heat from the burner 107 may be provided to the reformer 123 to increase the temperature of the reformer 123. If desired, the stack air exhaust stream may be provided adjacent to the reformer 123 to also increase the temperature of the reformer, as disclosed in U.S. application Ser. No. 11/002,681, filed Dec. 2, 2004, prior to being provided into the heat exchanger 127.

The fuel cell systems described herein may have other embodiments and configurations, as desired. Other components may be added if desired, as described, for example, in U.S. application Ser. No. 10/300,021, filed on Nov. 20, 2002, in U.S. Provisional Application Ser. No. 60/461,190, filed on Apr. 9, 2003, and in U.S. application Ser. No. 10/446,704, filed on May 29, 2003 all incorporated herein by reference in their entirety. Furthermore, it should be understood that any system element or method step described in any embodiment and/or illustrated in any figure herein may also be used in systems and/or methods of other suitable embodiments described above, even if such use is not expressly described.

The foregoing description of the invention has been presented for purposes of illustration and description. It is not intended to be exhaustive or to limit the invention to the precise form disclosed, and modifications and variations are possible in light of the above teachings or may be acquired from practice of the invention. The description was chosen in order to explain the principles of the invention and its practical application. It is intended that the scope of the invention be defined by the claims appended hereto, and their equivalents.

What is claimed is:

1. A fuel cell system, comprising:
a fuel cell stack;
a first fuel source that is adapted to supply a first fuel; and
a second fuel source that is adapted to supply a second fuel different from the first fuel;
wherein the fuel cell system is configured to switch from the first fuel to the second fuel during operation.

2. The fuel cell system of claim 1, wherein the fuel cell system is configured to continuously generate power when switching from the first to the second fuel.

3. The fuel cell system of claim 1, further comprising a third fuel source that is adapted to supply a third fuel different from the first and the second fuels, wherein the first fuel comprises a main fuel and the second and the third fuels comprise backup fuels.

4. The fuel cell system of claim 1, wherein the fuel cell system is configured to use the first fuel during a startup operation and the second fuel during steady-state operation.

5. The fuel cell system of claim 4, wherein the first fuel comprises natural gas, propane, ethanol, methanol, hydrogen, ammonia, and syn-gas.

6. The fuel cell system of claim 1, wherein the first fuel source comprises conduit connected to a natural gas pipeline and the second fuel source comprises a fuel storage vessel.

7. The fuel cell system of claim 1, wherein the first fuel is provided in a gas state and the second fuel is stored in a liquid state.

8. The fuel cell system of claim 1, further comprising a fractionation device.

9. The fuel cell system of claim 1, further comprising an auto-thermal reformation device.

10. The fuel cell system of claim 1, wherein at least one of the plurality of fuels is hydrogen produced by a reformation and stored for later use.

11. The fuel cell system of claim 1, further comprising a control system that controls the steam to carbon ratio.

12. The fuel cell system of claim 1, further comprising an interrupt signal device, wherein the fuel cell system is configured to switch fuels when the interrupt signal device produces a signal.

13. The fuel cell system of claim 1, wherein the fuel cell system is configured to detect an availability of at least one of the plurality of fuels by switching fuels to determine if the at least one fuel is available.

14. The fuel cell system of claim 1, wherein the first and the second fuels are selected from a group consisting of natural gas, propane, liquid petroleum gas, gasoline, diesel, home heating oil, kerosene, JP-5, JP-8, aviation fuels, hydrogen, ammonia, ethanol, methanol, syn-gas, bio-gas, and bio-diesel.

15. A method of operating fuel cell system, comprising:
operating a fuel cell stack on a first fuel; and
operating the fuel cell stack on a second fuel different from the first fuel after the step of operating the fuel cell stack on the first fuel.

16. The method of claim 15, wherein the fuel cell system is configured to continuously generate power when switching from the first to the second fuel.

17. The method of claim 15, wherein the first fuel comprises a main fuel and the second fuel comprises a backup fuel which is used when the first fuel becomes unavailable.

18. The method of claim 15, wherein the stack is operated on the first fuel during a startup operation and on the second fuel during steady-state operation.

19. The method of claim 15, wherein the first fuel comprises natural gas provided from a pipeline and the second fuel comprises a fuel stored in a fuel storage vessel.

20. The method of claim 15, wherein the first fuel comprises a gas and the second fuel comprises a liquid.

21. The method of claim 15, wherein the fuel cell stack switches from the first fuel to the second fuel when an interruption in a supply of the first fuel is detected.

22. The method of claim 15, wherein the first and the second fuels are selected from a group consisting of natural gas, propane, liquid petroleum gas, gasoline, diesel, home heating oil, kerosene, JP-5, JP-8, aviation fuels, hydrogen, ammonia, ethanol, methanol, syn-gas, bio-gas, and bio-diesel.

23. The method of claim 15, further comprising operating the fuel cell stack on third fuel different from the first and the second fuels after the step of operating the fuel cell stack on the second fuel.

24. The method of claim 23, wherein the first fuel comprises a main fuel, the second fuel comprises a primary backup fuel which is used when the first fuel becomes unavailable, and the third fuel comprises a secondary backup fuel which is used when the first and the second fuels become unavailable.

25. A method of operating fuel cell system, comprising:
operating a fuel cell stack on a fuel from a first fuel source; and
operating a fuel cell stack on a fuel from a second fuel source different from the first fuel source after the step of operating the fuel cell stack on the fuel from the first fuel source.
